(19) United States
(12) Patent Application Publication
(10) Pub. No.: US 2018/0132012 A1
(43) Pub. Date: May 10, 2018

(54) METHOD AND APPARATUS FOR PLAYING VIDEO IN APPLICATION PROGRAM

(71) Applicant: BEIJING QIHOO TECHNOLOGY COMPANY LIMITED, Beijing (CN)

(72) Inventors: Jihai REN, Beijing (CN); Baojiang DU, Beijing (CN); Xiangzhen ZHENG, Beijing (CN); Kai WU, Beijing (CN)

(21) Appl. No.: 15/563,928

(22) PCT Filed: Dec. 28, 2015
(86) PCT No.: PCT/CN2015/099225

§ 371 Date: Oct. 2, 2017

(30) Foreign Application Priority Data
Mar. 31, 2015 (CN) 201510149741.0

(51) Int. Cl. H04N 21/81; H04N 21/47; G06F 17/30; H04N 21/443

(52) U.S. Cl. CPC H04N 21/8173; H04N 21/47; H04N 21/4431; G06F 17/30873; G06F 17/3089

(57) ABSTRACT

The invention discloses a method and apparatus for playing a video in an application program, which relate to the field of video play technology. By judging whether a video page to be loaded in an application program belongs to a pre-cracked page library in which a correspondence relationship between video pages and video source addresses is stored, and employing a player embedded in the application program to play a video corresponding to the video source address when the video page to be loaded belongs to the pre-cracked page library, the invention thus achieves a unified play effect of video play and improves the user experience.

### FIELD OF THE INVENTION

The invention relates to the field of video play technology, and in particular, to a method and apparatus for playing a video in an application program.

### BACKGROUND OF THE INVENTION

With the rapid popularization of the internet and the full implementation of broadband networks, there are more and more video resources on the networks, and in this context, people's demands for video play are also growing.

However, in an application that needs to exhibit a variety of video class information, for example, a search application, it may exhibit videos on various video websites, but individual video websites have their own page presentation styles and play effects. The pages of some video websites are unaesthetic, the videos provided by some video websites are not clear, the page ads of some video websites are too many, or the ads of some video websites are too long, which all will affect the user experience when viewing a video.

### SUMMARY OF THE INVENTION

In view of the above problem, the invention is proposed to provide a method for playing a video in an application program and a corresponding apparatus, which overcome the above problem or at least partly solve the above problem.

According to an aspect of the invention, there is provided a method for playing a video in an application program comprising:

judging whether a video page to be loaded in the application program belongs to a pre-cracked page library in which a correspondence relationship between video pages and video source addresses is stored; and

employing a player embedded in the application program to play a video corresponding to the video source address when the video page to be loaded belongs to the pre-cracked page library.

According to another aspect of the invention, there is provided an apparatus for playing a video in an application program comprising:

a page judging unit configured for judging whether a video page to be loaded in the application program belongs to a pre-cracked page library in which a correspondence relationship between video pages and video source addresses is stored; and

a video play unit configured for employing a player embedded in the application program to play a video corresponding to the video source address when the video page to be loaded belongs to the pre-cracked page library.

According to still another aspect of the invention, there is provided a computer program comprising a computer readable code which causes a computing device to perform the method for playing a video in an application program as described above, when said computer readable code is running on the computing device.

According to yet still another aspect of the invention, there is provided a computer readable medium storing the above described computer program therein.

The beneficial effects of the invention lie in that:

by judging whether a video page to be loaded in an application program belongs to a pre-cracked page library in which a correspondence relationship between video pages and video source addresses is stored, and employing a player embedded in the application program to play a video corresponding to the video source address when the video page to be loaded belongs to the pre-cracked page library, the invention thus achieves a unified play effect of video play and improves the user experience.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 is a flow chart of a method for playing a video in an application program of an embodiment of the invention;

FIG. 2 is a flow chart of a method for playing a video in an application program of another embodiment of the invention;

FIG. 3 is a flow chart of a method for playing a video in an application program of still another embodiment of the invention;

FIG. 4 is a structural block diagram of an apparatus for playing a video in an application program of an embodiment of the invention;

FIG. 5 is a structural block diagram of an apparatus for playing a video in an application program of another embodiment of the invention;

FIG. 6 is a structural block diagram of an apparatus for playing a video in an application program of still another embodiment of the invention;

FIG. 7 shows schematically a block diagram of a computing device for performing a method for playing a video in an application program according to the invention; and FIG. 8 shows schematically a storage unit for retaining or carrying a program code implementing a method for playing a video in an application program according to the invention.

### DETAILED DESCRIPTION OF THE INVENTION

In the following the invention will be further described in conjunction with the drawings and the particular embodiments.

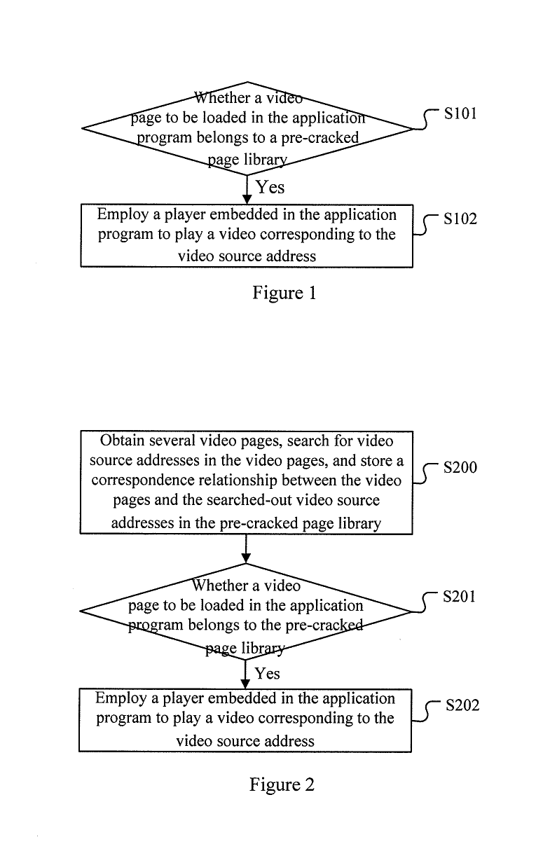

FIG. 1 is a flow chart of a method for playing a video in an application program of an embodiment of the invention. With reference to FIG. 1, the method comprises the following steps.

At S101, it is judged whether a video page to be loaded in the application program belongs to a pre-cracked page library in which a correspondence relationship between video pages and video source addresses is stored.

It needs to be noted that, a video page in the pre-cracked page library may be represented by its Uniform Resource Locator (URL), and of course, it may also be represented by a feature such as the video name, etc., which will not be limited by the embodiment.

It may be understood that, to facilitate a user to determine the video page to be loaded, in this embodiment, before the step S101, the method further comprises:

receiving a touch control instruction inputted by the user in the display interface of the application program, and according to the touch control instruction, determining the video page to be loaded corresponding to the touch control instruction.

It may be understood that, multiple ways may be adopted for the user to input the touch control instruction in the display interface of the application program, for example, a touch point on the screen of a mobile terminal is touch controlled by the user's finger or an inductive pen, and of course, other ways may also be adopted, which will not be limited by this embodiment.

In a specific implementation, to meet the search demand of the user, in this embodiment, before the receiving a touch control instruction inputted by the user in the display interface of the application program, the method further comprises:

receiving a search word inputted by the user, searching for webpage information related to the search word according to the search word, and exhibiting the searched-out webpage information in the display interface of the application program.

At S102, a player embedded in the application program is employed to play a video corresponding to the video source address when the video page to be loaded belongs to the pre-cracked page library.

It may be understood that, in general, the user's point of interest lies in the video itself, he will not be interested in the video page to be loaded, and exhibition of the video page to be loaded also requires a transcoding process, which needs a long response time and makes the user experience poor. To avoid the occurrence of this problem, in this embodiment, when it is determined that the video page to be loaded belongs to the pre-cracked page library, a player embedded in the application program is directly employed to play a video corresponding to the video source address, and the video page to be loaded will not be exhibited any more.

It needs to be noted that, to be able to facilitate the user to view a video, in this embodiment, the video corresponding to the video source address will be played in a full screen form when the player embedded in the application program is employed to play the video corresponding to the video source address.

By judging whether a video page to be loaded in an application program belongs to a pre-cracked page library in which a correspondence relationship between video pages and video source addresses is stored, and employing a player embedded in the application program to play a video corresponding to the video source address when the video page to be loaded belongs to the pre-cracked page library, the embodiment thus achieves a unified play effect of video play and improves the user experience. In addition, when it is determined that the video page to be loaded belongs to the pre-cracked page library, the player embedded in the application program is directly employed to play the video corresponding to the video source address, which further improves the user experience.

FIG. 2 is a flow chart of a method for playing a video in an application program of another embodiment of the invention. With reference to FIG. 2, the method comprises the following steps.

At S200, several video pages are obtained, video source addresses in the video pages are searched for, and a correspondence relationship between the video pages and the searched-out video source addresses is stored in the pre-cracked page library.

It needs to be noted that, multiple ways may be adopted when searching for video source addresses in the video pages. In order to increase the search efficiency, in this embodiment, video source addresses in the video pages are searched for by simulating a video play request of a page, namely, simulating a video play request sent by a video page when needing to playing a video, and of course, other ways may also be adopted to search for video source addresses in the video pages, which will not be limited by this embodiment.

It may be understood that several video pages may be obtained as needed, and however, since the amount of exhibition of the video page is too low, even if it is stored in the pre-cracked page library, it will be rarely used at subsequent step S201 and at the same time waste a certain memory space. To avoid the occurrence of this problem, in this embodiment, when several video pages are obtained, a few pages are first grabbed, and the amount of exhibition of an individual page is obtained, and when the amount of exhibition exceeds a preset threshold, then it is judged whether a video to be played exists in the page, and a page in which a video to be played exists is taken as a video page.

In a specific implementation, when it is judged whether a video to be played exists in the page, multiple ways may be adopted. For the convenience of judgment, in this embodiment, it is judged according to a page logic whether a video to be played exists in a page of which the amount of exhibition exceeds the preset threshold. Since a page is usually written in a language such as the HTML, etc., at the time of loading and exhibition, it is determined whether a video to be played exists in the page by analyzing its language such as the HTML, etc.

In addition, since video source addresses in the pre-cracked page library are likely to change, invalidity of a video source address will easily happen and video play failure will result if the pre-cracked page library has not been updated all the time after it was established. To avoid the occurrence of this problem, in this embodiment, after the step S200, there is further comprised: updating the pre-cracked page library every one preset time interval.

At S201, it is judged whether a video page to be loaded in the application program belongs to the pre-cracked page library in which a correspondence relationship between video pages and video source addresses is stored.

At S202, a player embedded in the application program is employed to play a video corresponding to the video source address when the video page to be loaded belongs to the pre-cracked page library.

The steps S201˜S202 are identical to the steps S101˜S102 of the embodiment as shown in FIG. 1, which will not be repeated here.

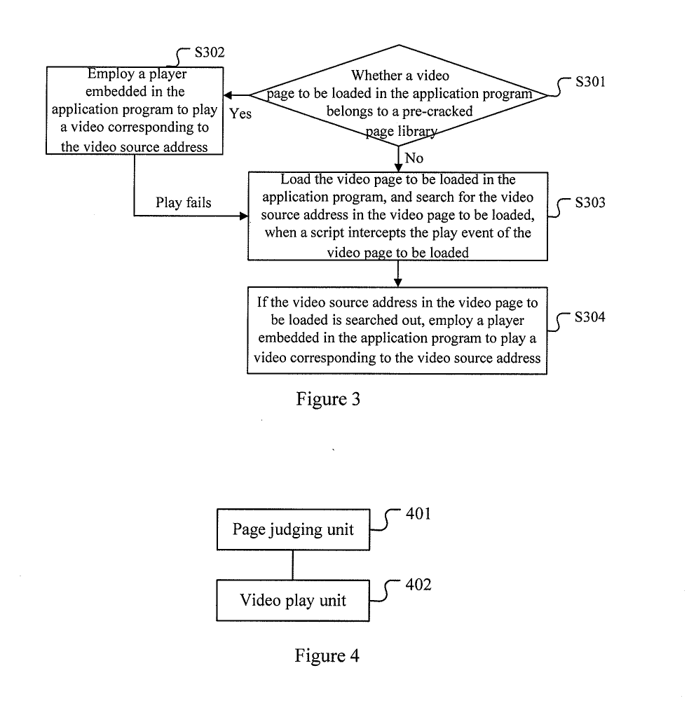

FIG. 3 is a flow chart of a method for playing a video in an application program of still another embodiment of the invention. With reference to FIG. 3, the method comprises the following steps.

At S301, it is judged whether a video page to be loaded in the application program belongs to a pre-cracked page library in which a correspondence relationship between video pages and video source addresses is stored.

At S302, a player embedded in the application program is employed to play a video corresponding to the video source address when the video page to be loaded belongs to the pre-cracked page library.

At S303, the video page to be loaded is loaded in the application program, when the video page to be exhibited does not belong to the pre-cracked page library at the step S301 or when the play of the player embedded in the application program fails at the step S302, and the video source address in the video page to be loaded is searched for, when a script intercepts the play event of the video page to be loaded, wherein the script is a script pre-injected in the application program for intercepting the play event of the video page to be loaded.

When the video source address in the video page to be loaded is searched for, this embodiment also searches for the video source address in the video page to be loaded by simulating a video play request of a page.

At step S304, if the video source address in the video page to be loaded is searched out, a player embedded in the application program is employed to play a video corresponding to the video source address.

It needs to be noted that, when the video page to be exhibited does not belong to the pre-cracked page library at the step S301, the video source address can not be obtained by searching the pre-cracked page library; and when the play of the player embedded in the application program fails at the step S302, it may be due to the existence of an error in the video source address in the pre-cracked page library, and the video source address can not be obtained by searching the video crack page library, either.

Therefore, in the above two situations, a video can not be played directly via the video source address, in which case it is only possible to load the video page to be loaded in the application program. To guarantee a unified play effect of video play, in this embodiment, first, the play event of the video page to be loaded is intercepted by a script, then the video source address in the video page to be loaded is searched for, and if the video source address in the video page to be loaded is searched out, the player embedded in the application program is employed to play a video corresponding to the video source address.

Of course, to ensure that when the video source address in the video page to be loaded is not searched out, a unified play effect of video play can also be guaranteed, in this embodiment, if the video source address in the video page to be loaded is not searched out, a video is played via the system native player (e.g., the native webview player in the android system).

Since the system native player may guarantee the purposiveness of play, in general, it may ensure that only a corresponding video is played and an ad. will not be inserted before the play or during the play, which further improves the user experience.

In addition, to ensure that the perception of the user when viewing a video via the system native player is consistent with that by the player embedded in the application program, in this embodiment, when video play is conducted via the system native player, the video is played via the system native player in a full screen form, and the play interface of the system native player is replaced by a preset interface.

For the method embodiments, for the sake of a simple description, they all are described as a combination of a series of actions. However, it will be known to the skilled in the art that, the embodiments of the invention are not limited by the described order of actions, since according to the embodiments of the invention, some steps may be performed in other order or simultaneously. Second, it will also be known to those skilled in the art that, the embodiments described in the specification all pertain to preferred embodiments, and the actions involved are not necessarily essential to the embodiments of the invention.

FIG. 4 is a structural block diagram of an apparatus for playing a video in an application program of an embodiment of the invention. With reference to FIG. 4, the apparatus comprises:

a page judging unit 401 configured to judge whether a video page to be loaded in the application program belongs to a pre-cracked page library in which a correspondence relationship between video pages and video source addresses is stored; and

a video play unit 402 configured to employ a player embedded in the application program to play a video corresponding to the video source address when the video page to be loaded belongs to the pre-cracked page library.

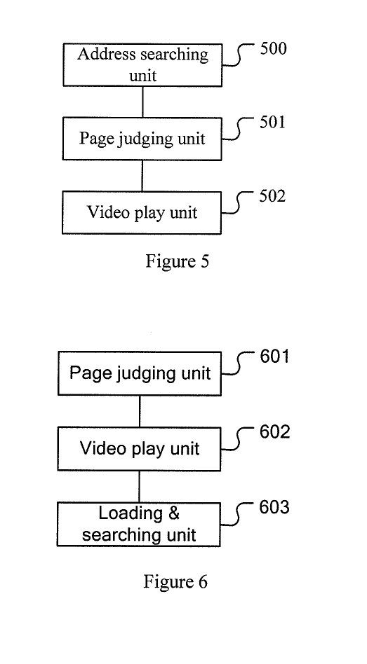

FIG. 5 is a structural block diagram of an apparatus for playing a video in an application program of another embodiment of the invention. With reference to FIG. 5, the apparatus comprises:

an address searching unit 500 configured to obtain several video pages, search for video source addresses in the video pages, and store a correspondence relationship between the video pages and the searched-out video source addresses in the pre-cracked page library;

a page judging unit 501 configured to judge whether a video page to be loaded in the application program belongs to the pre-cracked page library in which a correspondence relationship between video pages and video source addresses is stored; and

a video play unit 502 configured to employ a player embedded in the application program to play a video corresponding to the video source address when the video page to be loaded belongs to the pre-cracked page library.

In an optional embodiment of the invention, the address searching unit 500 is further configured to search for video source addresses in the video pages by simulating a video play request of a page.

In an optional embodiment of the invention, the address searching unit 500 is further configured to grab several pages and obtain the amount of exhibition of an individual page; and judge whether a video to be played exists in a page of which the amount of exhibition exceeds a preset threshold, and take a page in which a video to be played exists as a video page.

In an optional embodiment of the invention, the address searching unit 500 is further configured to judge according to a page logic whether a video to be played exists in a page of which the amount of exhibition exceeds the preset threshold.

In an optional embodiment of the invention, the apparatus further comprises:

a data updating unit (not shown in the figure) configured to update the pre-cracked page library every one preset time interval.

In an optional embodiment of the invention, the apparatus further comprises:

a touch control receiving unit (not shown in the figure) configured to receive a touch control instruction inputted by the user in the display interface of the application program, and according to the touch control instruction, determine the video page to be loaded corresponding to the touch control instruction.

In an optional embodiment of the invention, the apparatus further comprises:

an input & search unit (not shown in the figure) configured to receive a search word inputted by the user, search for webpage information related to the search word according to the search word, and exhibit the searched-out webpage information in the display interface of the application program.

FIG. 6 is a structural block diagram of an apparatus for playing a video in an application program of still another embodiment of the invention. With reference to FIG. 6, the apparatus comprises:

a page judging unit 601 configured to judge whether a video page to be loaded in the application program belongs to a pre-cracked page library in which a correspondence relationship between video pages and video source addresses is stored;

a video play unit 602 configured to employ a player embedded in the application program to play a video corresponding to the video source address when the video page to be loaded belongs to the pre-cracked page library;

a loading & searching unit 603 configured to loading the video page to be loaded in the application program, when the video page to be exhibited does not belong to the pre-cracked page library or when the play of the player embedded in the application program fails, and search for the video source address in the video page to be loaded, when a script intercepts the play event of the video page to be loaded, wherein the script is a script pre-injected in the application program for intercepting the play event of the video page to be loaded; and

the video play unit 602 is further configured to, when the video source address in the video page to be loaded is searched out, employing a player embedded in the application program to play a video corresponding to the video source address.

In an optional embodiment of the invention, the loading & searching unit 603 is further configured to search for the video source address in the video page to be loaded by simulating a video play request of a page.

In an optional embodiment of the invention, the video play unit 602 is further configured to play a video via the system native player when the video source address in the video page to be loaded is not searched out.

In an optional embodiment of the invention, the video play unit 602 is further configured to play a video via the system native player in a full screen form, and replace the play interface of the system native player by a preset interface.

In an optional embodiment of the invention, the video play unit 602 is further configured to employ a player embedded in the application program to play a video corresponding to the video source address in a full screen form.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in an apparatus for playing a video in an application program according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

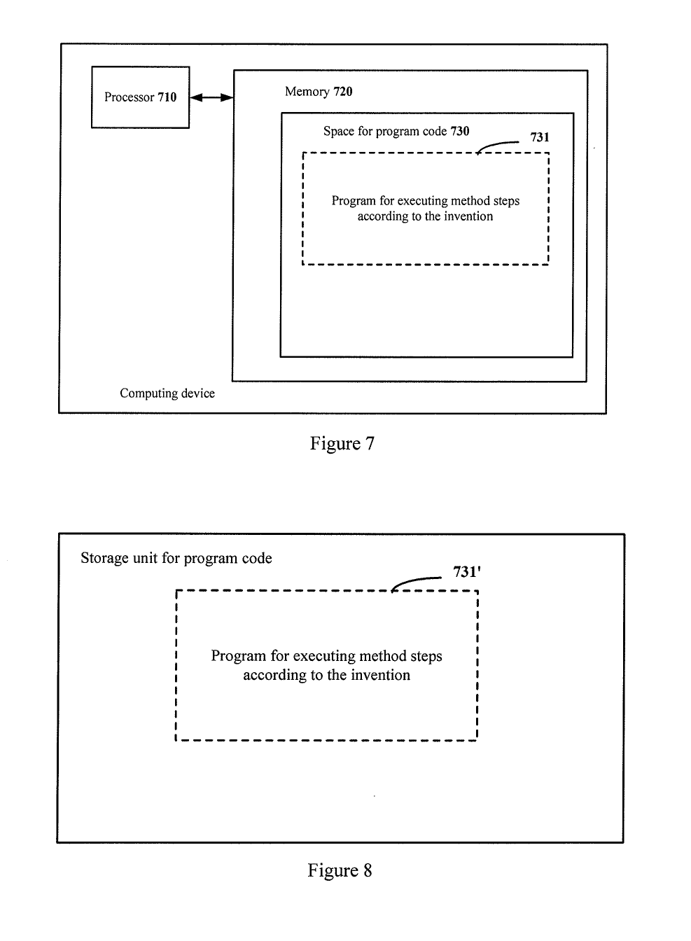

For example, FIG. 7 shows a computing device which may carry out a method for playing a video in an application program. The computing device traditionally comprises a processor 710 and a computer program product or a computer readable medium in the form of a memory 720. The memory 720 may be an electronic memory such as a flash memory, an EEPROM (electrically erasable programmable read-only memory), an EPROM, a hard disk or a ROM. The memory 720 has a memory space 730 for a program code 731 for carrying out any method steps in the methods as described above. For example, the memory space 730 for a program code may comprise individual program codes 731 for carrying out individual steps in the above methods, respectively. The program codes may be read out from or written to one or more computer program products. These computer program products comprise such a program code carrier as a hard disk, a compact disk (CD), a memory card or a floppy disk.

Such a computer program product is generally a portable or stationary storage unit as described with reference to FIG. 8. The storage unit may have a memory segment, a memory space, etc. arranged similarly to the memory 720 in the computing device of FIG. 7. The program code may for example be compressed in an appropriate form. In general, the storage unit comprises a computer readable code 731′, i.e., a code which may be read by e.g., a processor such as 710, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for playing a video in an application program, comprising:
judging whether a video page to be loaded in the application program belongs to a pre-cracked page library in which a correspondence relationship between video pages and video source addresses is stored; and
employing a player embedded in the application program to play a video corresponding to the video source address when the video page to be loaded belongs to the pre-cracked page library.

2. The method as claimed in claim 1, wherein before the judging whether a video page to be loaded in the application program belongs to a pre-cracked page library, the method further comprises:
obtaining several video pages, searching for video source addresses in the video pages, and storing a correspondence relationship between the video pages and the searched-out video source addresses in the pre-cracked page library.

3. The method as claimed in claim 2, wherein the searching for video source addresses in the video pages further comprises:
searching for video source addresses in the video pages by simulating a video play request of a page.

4. The method as claimed in claim 2, wherein the obtaining several video pages further comprises:
grabbing several pages and obtaining the amount of exhibition of an individual page; and
judging whether a video to be played exists in a page of which the amount of exhibition exceeds a preset threshold, and taking a page in which a video to be played exists as a video page.

5. The method as claimed in claim 4, wherein the judging whether a video to be played exists in a page of which the amount of exhibition exceeds a preset threshold further comprises:
judging according to a page logic whether a video to be played exists in a page of which the amount of exhibition exceeds the preset threshold.

6. The method as claimed in claim 2, wherein after the storing a correspondence relationship between the video pages and the searched-out video source addresses in the pre-cracked page library, the method further comprises:
updating the pre-cracked page library every one preset time interval.

7. The method as claimed in claim 1, wherein before the judging whether a video page to be loaded in the application program belongs to a pre-cracked page library, the method further comprises:
receiving a touch control instruction inputted by the user in the display interface of the application program, and according to the touch control instruction, determining the video page to be loaded corresponding to the touch control instruction.

8. The method as claimed in claim 7, wherein before the receiving a touch control instruction inputted by the user in the display interface of the application program, the method further comprises:
receiving a search word inputted by the user, searching for webpage information related to the search word according to the search word, and exhibiting the searched-out webpage information in the display interface of the application program.

9. The method as claimed in claim 1, further comprising:
loading the video page to be loaded in the application program, when the video page to be exhibited does not belong to the pre-cracked page library or when the play of the player embedded in the application program fails, and searching for the video source address in the video page to be loaded, when a script intercepts the play event of the video page to be loaded, wherein the script is a script pre-injected in the application program for intercepting the play event of the video page to be loaded; and
if the video source address in the video page to be loaded is searched out, employing a player embedded in the application program to play a video corresponding to the video source address.

10. The method as claimed in claim 9, wherein the searching for the video source address in the video page to be loaded further comprises:
searching for the video source address in the video page to be loaded by simulating a video play request of a page.

11-13. (canceled)

14. An apparatus for playing a video in an application program, comprising:
a memory having instructions stored thereon;
a processor configured to execute the instructions to perform following operations:
judging whether a video page to be loaded in the application program belongs to a pre-cracked page library in which a correspondence relationship between video pages and video source addresses is stored; and
employing a player embedded in the application program to play a video corresponding to the video source address when the video page to be loaded belongs to the pre-cracked page library.

15. The apparatus as claimed in claim 14, wherein before the judging whether a video page to be loaded in the application program belongs to a pre-cracked page library, the operations further comprise:
obtaining several video pages, search for video source addresses in the video pages, and storing a correspondence relationship between the video pages and the searched-out video source addresses in the pre-cracked page library.

16. The apparatus as claimed in claim 15, wherein the searching for video source addresses in the video pages further comprises:
searching for video source addresses in the video pages by simulating a video play request of a page.

17. The apparatus as claimed in claim 15, wherein the obtaining several video pages further comprises:
grabbing several pages and obtaining the amount of exhibition of an individual page; and
judging whether a video to be played exists in a page of which the amount of exhibition exceeds a preset threshold, and taking a page in which a video to be played exists as a video page.

18. The apparatus as claimed in claim 17, wherein the judging whether a video to be played exists in a page of which the amount of exhibition exceeds a preset threshold further comprises:
judging according to a page logic whether a video to be played exists in a page of which the amount of exhibition exceeds the preset threshold.

19. The apparatus as claimed in claim 15, wherein after the storing a correspondence relationship between the video pages and the searched-out video source addresses in the pre-cracked page library, the operations further comprise:
updating the pre-cracked page library every one preset time interval.

20. The apparatus as claimed in claim 14, wherein before the judging whether a video page to be loaded in the application program belongs to a pre-cracked page library, the operations further comprise:
receiving a touch control instruction inputted by the user in the display interface of the application program, and according to the touch control instruction, determining the video page to be loaded corresponding to the touch control instruction.

21. The apparatus as claimed in claim 20, wherein before the receiving a touch control instruction inputted by the user in the display interface of the application program, the operations further comprise:
receiving a search word inputted by the user, searching for webpage information related to the search word according to the search word, and exhibiting the searched-out webpage information in the display interface of the application program.

22. The apparatus as claimed in claim 14, the operations further comprise:
loading the video page to be loaded in the application program, when the video page to be exhibited does not belong to the pre-cracked page library or when the play of the player embedded in the application program fails, and searching for the video source address in the video page to be loaded, when a script intercepts the play event of the video page to be loaded, wherein the script is a script pre-injected in the application program for intercepting the play event of the video page to be loaded; and
when the video source address in the video page to be loaded is searched out, employing a player embedded in the application program to play a video corresponding to the video source address.

23-27. (canceled)

28. A non-transitory computer readable medium having instructions stored thereon that, when executed by at least one processor, cause the at least one processor to perform following operations:
judging whether a video page to be loaded in the application program belongs to a pre-cracked page library in which a correspondence relationship between video pages and video source addresses is stored; and
employing a player embedded in the application program to play a video corresponding to the video source address when the video page to be loaded belongs to the pre-cracked page library.
